(19) United States
(12) Patent Application Publication
(10) Pub. No.: US 2026/0370582 A1
(43) Pub. Date: Nov. 19, 2026

(54) STATELESS PACKET LOSS DETECTION IN A NETWORK

(71) Applicant: Mellanox Technologies, Ltd., Yokneam (IL)

(72) Inventors: Yamin Friedman, Jerusalem (IL); Idan Borshteen, Carmiel (IL); Kfir Assor, Haifa (IL); Elazar Cohen, Haifa (IL); Ariel Shahar, Jerusalem (IL); Eitan Zahavi, Zichron Yaakov (IL)

(21) Appl. No.: 19/207,157

(22) Filed: May 13, 2025

(51) Int. Cl. H04L 43/0829; H04L 47/34

(52) U.S. Cl. CPC H04L 43/0829; H04L 47/34

(57) ABSTRACT

A method for stateless packet loss detection in a network. The method includes sending a first number of packets to a destination device via a first network path based on a packet sending criterion, sending a second number of packets to the destination device via a second network path based on the packet sending criterion, receiving an acknowledgement from the destination device, wherein the acknowledgement comprises a first indication that one or more of the first number of packets arrived at the destination device, and determining that at least one packet sent via the first network path was dropped based on the first number of packets and the first indication.

### TECHNICAL FIELD

At least one embodiment pertains to network management. In particular, aspects and implementations of the present disclosure relate to a stateless packet loss detection in a network.

### BACKGROUND

The number of servers connected within a datacenter is growing rapidly. These datacenters can be organized in a hierarchical structure resembling a tree with multiple network layers. Modern network transports utilize packet spraying to improve network utilization within the multiple network layers and avoid collisions.

### BRIEF DESCRIPTION OF DRAWINGS

Various embodiments in accordance with aspects of the disclosure will be described with reference to the drawings, in which:

FIGS. 1A-B illustrates a system, according to some aspects of the disclosure.

FIG. 2 illustrates a fat tree topology for a datacenter, according to some aspects of the disclosure.

FIGS. 3A-D illustrate example networking paths in the fat tree topology of FIG. 2 described above, according to some aspects of the disclosure.

FIG. 4A is a flow diagram of an example method for stateless packet loss detection in a network, according to aspects of the disclosure.

FIG. 4B is a flow diagram of an example method for stateless packet loss detection in a network, according to aspects of the disclosure.

FIG. 5A illustrates an example communication system, according to some aspects of the disclosure.

FIG. 5B is a block diagram that schematically illustrates a communication system, according to some aspects of the disclosure.

FIG. 6 illustrates an exemplary data center, according to some aspects of the disclosure.

FIG. 7 illustrates an example datacenter, according to some aspects of the disclosure.

FIG. 8 is a block diagram of a computing system having two processing devices coupled to each other and multiple networks according to some aspects of the disclosure.

FIG. 9 is a block diagram of a computing system having a CPU and a GPU in a single integrated circuit, according to some aspects of the disclosure.

FIG. 10 is a block diagram of a computing system having tensor core GPUs, according to some aspects of the disclosure

### DETAILED DESCRIPTION

Datacenters often include multiple switching layers to connect many servers. As datacenters grow, the number of connections needed for the data center can grow rapidly. Many datacenters are organized in a hierarchical set of network layers. Data flows in from the lower layers and can be aggregated with data that has a similar destination as it moves up through the network layers. A switching component in the top layer can then direct a batch of data with the same or similar destinations. Alternatively, switching components in the top layer can direct data to locations not accessible by the lower network layers.

As data flows through the hierarchical network layers of a datacenter, it traverses various paths that determine its route from a source device to a destination device. As used herein, “network path” refers to a possible route that a data packet takes from a source device (e.g., a sender device) to a destination device (e.g., receiver device) within a network. Network paths are shaped by both the physical and logical structure of the network, as well as the routing protocols and traffic management algorithms that govern data movement. The efficiency and reliability of these paths play a critical role in ensuring that data packets reach their intended destinations, whether they are being aggregated at higher switching layers or directed to locations inaccessible from lower layers.

To optimize network utilization and mitigate flow collisions, some modern network transports use packet spraying, a technique that distributes data packets across multiple available network paths. While packet spraying may enhance throughput and/or balance network traffic loads, it introduces challenges in maintaining state information for each path, especially in large-scale datacenters with numerous potential routes. One way to address this challenge is by maintaining a list of each network path and tracking which packets were sent along each route. However, as the number of paths increases, storing and managing this information becomes increasingly complex, making it more difficult to quickly detect and respond to packet loss.

Additionally, packet spraying complicates loss detection, as it becomes more difficult to infer packet loss from the arrival of subsequent packets from the same network path. As packets are dispersed across more network paths, the ability to infer packet loss for any single network path becomes less reliable, potentially delaying the detection and recovery of lost data.

Aspects of the present disclosure address these and other challenges through stateless packet loss detection in a network. A packet sender selects a network path and sends a set of packets. The set of packets can be sequentially numbered as they are sent. A packet receiver receives one or more of the packets and sends a message back of the packet numbers that were received. Because the packet sender is aware that a specific number of packets were sent on the same network path, the packet sender can determine that a packet loss occurred if the message (e.g., an acknowledgement message) from the packet receiver indicates that a higher packet number (e.g., packet 10) was received before a lower packet number (e.g., packet 1). In this way, a connectivity status of the network path is determined. For example, if the acknowledgment messages indicates that packets 1-8 and packet 10 were received, then 9/10 packets were received which indicates a level of congestion on the network path. As the number of dropped packets increases, the level of congestion on the network path also increases. The packet sender can predetermine the number of packets to send via different network paths.

Advantages of the disclosure include, but are not limited to determining packet loss per network path without particular knowledge about the characteristics or status of each network path. Instead, only the number of packets sent on a network path before selecting a new network path is used to determine the packet loss for the network path/network. Additional advantages include an increased detection of dropped packets, improved data recovery, improved diagnosis of faulty network paths, a reduction in computing resources to track network path connectivity status',

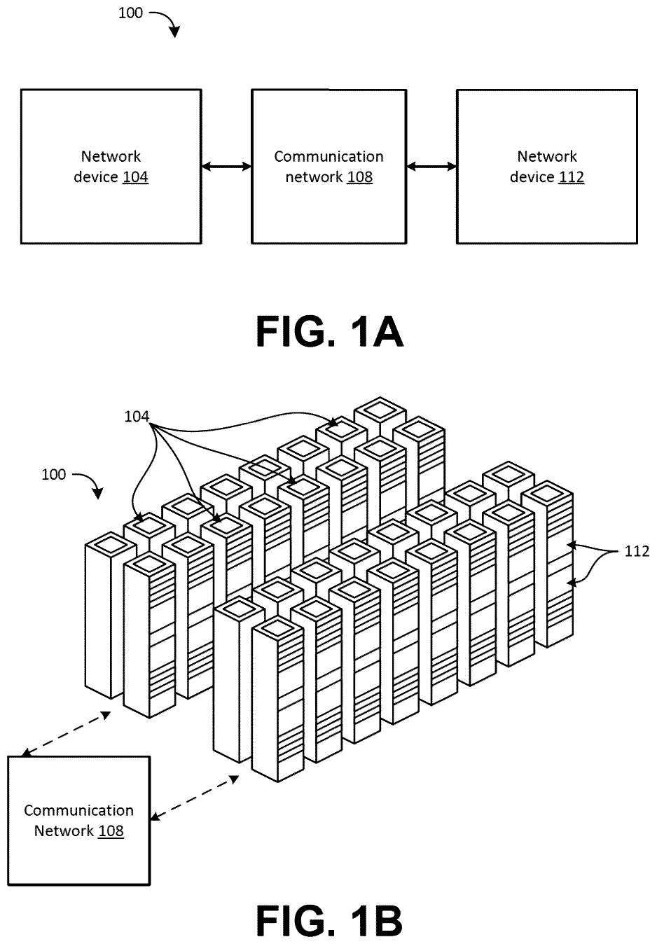

FIG. 1A Illustrates a system 100 according to some aspects of the disclosure. The system 100 includes a network device 104, a communication network 108, and a network device 112 (also referred to hereinafter as a “network element”). In at least one example embodiment, network devices 104 and 112 may correspond to a network switch (e.g., an Ethernet switch), a network interface controller (NIC), or any other suitable device used to control the flow of data between devices connected to communication network 108. Each network device 104 and 112 may be connected to one or more of Personal Computer (PC), a laptop, a tablet, a smartphone, a server, a collection of servers, a GPU, or the like. In one specific, but non-limiting example, each network device 104 and 112 includes multiple network switches in a fixed configuration or in a modular configuration. The switches within each layer (e.g., edge layer, aggregation layer, core layer) may be 1U switches, where “1U” refers to the industry-standard size for rack-mounted switches and servers. The switches may be electrical switches, optical switches, hybrid electro-optical switches, or any combination thereof. The switches may be implemented with suitable hardware and/or software that enables the routing of signals in the appropriate domain. For example, an electrical switch may include receivers that receive and convert optical signals into electrical signals for routing within the electrical switch. A receiver of an electrical switch may include a transimpedance amplifier (TIA), a photodetector, and a controller which all serve to convert the optical signals into electrical signals. Each electrical switch may further include transmitters that convert electrical signals routed within the electrical switch into optical signals for output to another switch (optical or electrical) within the system. For example, a transmitter of an electrical switch may include a light source, a modulator, and a controller that controls the modulator and light source. In some embodiments, receiver/transmitter pairs may be integrated into a single transceiver. Each electrical switch may also include internal switching circuitry for routing electrical signals within the electrical switch.

In some embodiments, the network device 104 can be a rack in a datacenter, as illustrated in FIG. 1B. Datacenters may include multiple network switches in a particular topology, such as a fat tree topology, a slim fly topology, or indirect network topology (e.g. folded-Clos or a dragonfly topology), and/or the like. The specifications and makeup of the network switches in the topology affects the overall network performance (e.g., bandwidth capability) of the datacenter.

High performance computing clusters, and/or the like are often formed of various computing components or networked devices, and communication networks formed of electrical and/or optical devices may be used to enable communication between the networked devices forming these implementations.

For example, the network device 104 may be a centralized facility designed to house computing resources and related components. The network device 104 may operate to support the infrastructure required for advanced computational tasks, for efficient, secure, and reliable operations. The network device 104 may include the building and structural components, including power supplies, cooling systems, fire suppression systems, and physical security measures that are configured to maintain optimal operating conditions and/or protect the equipment from environmental hazards and unauthorized access. An example network device 104 may include high-performance servers or compute nodes, often arranged in racks, such as those illustrated in FIG. 1B, and connected through high-speed networks as described herein. These servers may include processors (e.g., central processing units (CPUs), graphics processing units (GPUs), data processing units (DPUs) and/or the like), memory (e.g., RAM), and storage solutions (e.g., hard disk drives (HDDs), solid state drives (SSDs), and/or the like. The hardware configuration may be designed for parallel processing and high throughput, catering to the demands of high-performance computing (HPC) applications.

The network device 104 may include high-speed network equipment, such as network switches, routers, firewalls, and/or the like to facilitate fast and secure data transmission within the network device 104 (e.g., between the servers or compute nodes) and between external networks. The network device 104 may facilitate communication between servers or compute nodes through a network topology that ensures efficient data exchange, minimizes latency, and maximizes bandwidth. The network topology may dictate how various network devices, such as switches and routers, are interconnected for data flow. By implementing an effective network topology, the network device 104 may support high-performance computing tasks. Examples of various network topologies may include hierarchical networking topologies such as the fat tree topology, Slim Fly topology, Dragonfly topology, and/or the like.

Examples of the communication network 108 that may be used to connect the network devices 104 and 112 include an Internet Protocol (IP) network, an Ethernet network, an InfiniBand (IB) network, a Fibre Channel network, an NVLink fabric, the Internet, a cellular communication network, a wireless communication network, combinations thereof (E.g., Fibre Channel over Ethernet), variants thereof, and/or the like. In one specific, but non-limiting example, the communication network 108 is a network that enables communication between the network devices 104 and 112 using Ethernet technology.

As discussed in more detail below, each network device 104 and 112 may be connected to a communication network 108 that has multiple network switching layers. The number of network devices 104 and 112 that may be connected to the communication network 108 can be increased by increasing the radix of the communication network 108. The radix of the communication network 108 is increased by increasing the radix of each network layer in the communication network 108. The radix of each network layer is increased using optical shuffle boxes that implement wavelength division multiplexing as described herein below in embodiments. The communication network 108 can include one or more electrical switches, optical switches, electrooptical transceivers, or the like, as described herein below.

The communication network 108 may communicably couple the network device 104 with network device 112 and other external devices for data exchange and connectivity. Examples of the communication network 108 may include an Internet Protocol (IP) network, an Ethernet network, an InfiniBand (IB) network, a Fibre Channel network, an NVLink fabric, the Internet, a cellular communication network, a wireless communication network, combinations thereof (e.g., Fibre Channel over Ethernet), variants thereof, and/or the like. The ability of the communication network 108 to incorporate multiple network types and configurations may allow the network device 104 to adapt to diverse application needs, from general data communication to specialized HPC tasks. As described herein, the communication network 108 may leverage various optical components to establish communication links (e.g., communicably couple) between components in the computing system 100. As such, the communication network 108 may include various optical devices, transceivers, modules, and/or the like that are configured to generate optical data signals (e.g., provide optical transmitter functionality) and/or receive optical data signals (e.g., provide optical receiver functionality).

The network device 112 may include a variety of computing devices capable of transmitting and receiving signals over the communication network 108. The network device 112 may range from personal computing devices to complex server configurations. Examples include Personal Computers (PCs), laptops, tablets, smartphones, and servers. The network device 112 may facilitate user interactions with the network device 104, allowing for data input, retrieval, and processing from remote locations. In addition to individual computing devices, the network device 112 may also include collections of servers or additional datacenters. For instance, these could be other datacenters similar to or the same as network device 104. Such an interconnection may allow for the formation of a distributed computing environment for improved redundancy, load balancing, and disaster recovery capabilities. By linking multiple datacenters, the system 100 may leverage geographically dispersed resources, optimizing performance and ensuring high availability.

As described herein, the network device 104 and/or the network device 112 may include storage devices and processing circuitry for executing computing tasks, such as controlling the flow of data internally and over the communication network 108. The processing circuitry may include software, hardware, or a combination thereof. For example, the processing circuitry may include a memory containing executable instructions and a processor (e.g., a microprocessor) that executes these instructions. The memory may correspond to any suitable type of memory device or collection of memory devices configured to store instructions. Non-limiting examples of suitable memory devices include Flash memory, Random Access Memory (RAM), Read Only Memory (ROM), variants thereof, combinations thereof, or similar technologies. In specific embodiments, the memory and processor may be integrated into a common device, such as a microprocessor with integrated memory. Additionally, or alternatively, the processing circuitry may comprise hardware components, such as an application-specific integrated circuit (ASIC). Other non-limiting examples of processing circuitry include Integrated Circuit (IC) chips, CPUs, GPUs, microprocessors, Field Programmable Gate Arrays (FPGAs), collections of logic gates or transistors, resistors, capacitors, inductors, and diodes. Some or all of the processing circuitry may be provided on a Printed Circuit Board (PCB) or a collection of PCBs. It should be appreciated that any appropriate type of electrical component or collection of electrical components may be suitable for inclusion in the processing circuitry.

In addition, although not explicitly shown, the present disclosure contemplates that the network device 104 and network device 112 may include one or more communication interfaces for facilitating wired and/or wireless communication between one another and other unillustrated elements of the system 100. These communication interfaces may include a variety of technologies, including but not limited to Ethernet ports, fiber optic connections, Wi-Fi® transceivers, Bluetooth® modules, and cellular communication modules for integration and interoperability among the various components within the system 100.

Furthermore, the present disclosure contemplates that the system 100 may include additional components and functionalities. For example, the network architecture may include, without limitation, additional processing units, specialized accelerators (such as Tensor Processing Units or TPUs), enhanced security modules, and redundant power supplies. The inclusion of these elements may be intended to ensure that the system 100 is robust, scalable, and capable of meeting diverse operational requirements. Any variations, modifications, or adaptations of the described elements that fall within the spirit and scope of the disclosure are considered to be encompassed by the present disclosure. This includes any combinations, sub-combinations, or enhancements of the various described elements to achieve improved performance, reliability, and efficiency in the system 100.

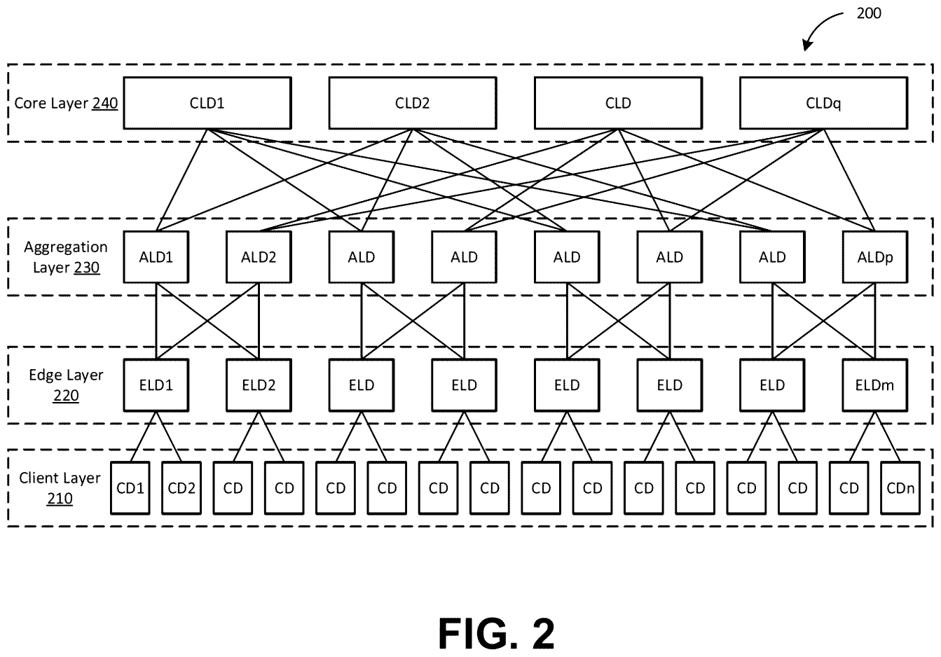

FIG. 2 illustrates a fat tree topology 200 for a datacenter, according to some aspects of the disclosure. However, it is to be understood that the present disclosure is not limited to a fat tree topology. Other network topologies may also be contemplated within the scope of the disclosure. Examples of such alternative topologies include, but are not limited to, Slim Fly topology, which is designed to reduce the number of hops and cable lengths between nodes; Dragonfly topology, which aims to enhance network scalability and reduce latency through a hierarchical group of interconnected switches; and other hierarchical or non-hierarchical topologies that may be optimized for specific performance, scalability, or cost considerations. The principles and innovations disclosed herein can be applied to these and other network topologies to achieve similar advantages and benefits. Any modifications, variations, or adaptations of the network topologies that fall within the spirit and scope of the present disclosure are considered to be encompassed by this disclosure. In related art systems, a fat tree topology may use the same electrical switching devices on all layers (edge, aggregation, core). For example, each switching device may be 1 U switch, where 1 U refers to the industry standard size for rack-mounted switch and/or server. The interconnection between switches of different layers may be accomplished with optical links using active optical cables and optical transceivers implemented in a pluggable form factor (also referred to as “pluggables”).

As shown in FIG 2, the client layer 210 includes client devices CD1, CD2, . . . , CDn that are connected by three distinct networking layers of the fat tree topology 200. In some embodiments, the fat tree topology may include three distinct networking layers: the edge layer 220, the aggregation layer 230, and the core layer 240. The edge layer 220, located at the bottom of the hierarchy, incorporates Top-of-Rack (ToR) network devices, such as network switches. In an alternative embodiment, the edge layer 220 can incorporate an End-of-Row (EoR) or Middle-of-Row (MoR) network devices, such as network switches. The edge layer 220 may serve as the initial point of aggregation for traffic originating from the servers. The servers and server racks are generally connected to the edge layer 220, although they are not illustrated in the figure. The edge layer 220 may include multiple network devices, designated as ELD1, ELD2, . . . , ELDm, as shown in FIG. 2. In some embodiments, the network devices in the edge layer 220 are network switches, such as electrical network switches. The aggregation layer 230 may be positioned above the edge layer 220 and may further consolidate traffic from multiple edge layer 220 network devices ELD1, ELD2, . . . , ELDp. The aggregation layer 230 may be composed of network devices ALD1, ALD2, . . . , ALDq. In some embodiments, the network devices of the aggregation layer 230 are network switches, such as optical network switches. The aggregation layer devices may be configured to aggregate data traffic from the edge layer 220, ensuring efficient load balancing and data flow management. At the top of the hierarchy is the core layer 240, which may provide high-speed interconnectivity and enables communication among different racks within the datacenter. The core layer 240 may include a series of network devices labeled as CLD1, CLD2, . . . , CLDp. These core layer network devices (e.g., network switches) may be configured to ensure that data can traverse the network quickly and efficiently, minimizing latency and maximizing bandwidth.

As described herein, a high-capacity optical switch assemblies switch multiple channels of data at high data rates, with the number of channels reaching several hundreds and data rates reaching hundreds of Gb/s (Gb/s=10⁹ bits per second). In order to save power, it is desirable to co-package the switch itself with “optical engines,” which typically are small, high-density optical transceivers located within an application-specific integrated circuit (ASIC) or within an ASIC package together with the switch. The switch assembly is contained in a rack-mounted case, with optical receptacles on its front panel for ease of access. The signals from and to the ASIC are conveyed to and from the optical receptacles using optical fibers.

To further simplify installation and use, it is sometimes desirable that the optical cable be detachable from the transceivers so that a smaller cable may be routed through an installation. Each optical cable may, instead of comprising a transceiver, be designed to mate with a particular transceiver. The transceiver may be connected to a node, such as a server, and be used to connect a connector of each cable to the node as described herein.

Optical switches are one solution for enabling advances in networking due to the technology's potential for very high data capacity and low power consumption. Optical switches feature optical input and output ports and are capable of routing light that is coupled to the input ports to the intended output ports on demand, according to one or more control signals (electrical or optical control signals). Routing of the signals is performed in the optical domain, i.e. without the need for optical-electrical and electrical-optical conversion, thus bypassing the need for power-consuming transceivers. Header processing and buffering of the data is not possible in the optical domain and thus, packet switching (as it is realized in electrical switches) cannot be employed. Instead, the circuit switching paradigm is used: an end-to-end circuit is created for the communication between two endpoints connected on the input and the output of the optical switch. Director switches may be used in the most common datacenter interconnection topologies, e.g., fat trees, Slim Fly, and Dragonfly+).

An optical switch may include hardware and/or software for routing signals in the optical domain. Thus, in one embodiment, an optical switch may include input optical fibers and output optical fibers that carry optical signals as well as one or more devices suited for routing optical signals within the optical switch. For example, the one or more devices for routing optical signals may include one or more movable mirrors (e.g., MEMS mirrors) that are controlled to move in a manner that directs light from an input fiber to a desired output fiber or to move in a manner that forces or guides light from one waveguide into another waveguide. An optical switch may include one or more devices for amplifying light in order to compensate for propagation and scattering losses introduced by the optical switch. In at least one example embodiment, signals input and output to an ASIC are optical, meaning that each optical switch connected to an electrical switch routes optical signals received from the electrical switch without using hardware and/or software that converts an electrical signal into an optical signal for routing within the optical switch. However, example embodiments are not limited thereto, and an optical switch may include electrical to optical to electrical conversion hardware and/or software if desired (e.g., if the input signal and/or output signal is an electrical signal).

In some embodiments, the optical switch(es) may include an arrayed waveguide grating router (AWGR), which is a passive switch fabric. In some embodiments, the optical switch(es) may correspond to a passive element that operates as a wavelength router that uses multiple wavelengths to interconnect outputs and inputs by following a specific cyclic wavelength routing pattern.

In alternative embodiments, an optical switch may function by directly routing optical signals without converting them to electrical signals. Each optical switch may include optical receivers, such as photodetectors and wavelength-division multiplexing (WDM) demultiplexers, that receive incoming optical signals. These optical signals may then be directed through internal optical switching components, such as micro-electromechanical systems (MEMS) mirrors, waveguides, or optical cross-connects, which route the signals to the appropriate output paths. The optical switch may also include optical transmitters, such as laser diodes and modulators, which transmit the routed optical signals to the next switch in the network. A hybrid electro-optical switch (e.g., a “pod” as illustrated in FIG. 2) may combine both electrical and optical components to route signals. Such a switch may include receivers that convert optical signals into electrical signals using TIAs and photodetectors, similar to those in electrical switches. These electrical signals can then be routed within the switch using internal electrical switching circuitry. Additionally, the hybrid switch may contain optical switching components, such as WDM multiplexers and MEMS devices, to route optical signals directly. The transmitters in a hybrid switch may include both electrical-to-optical converters and direct optical transmitters, enabling the hybrid switch to interface with both electrical and optical networks. For example, a hybrid switch's transmitter may include a light source, a modulator for optical signals, and traditional electrical signal transmitters, providing routing capabilities across different signal domains.

The interconnections between the switches within the network topology 200 may be implemented via optical fibers or traditional electrical cables, depending on the specific requirements of the system. For instance, the communication lanes may be constructed of dedicated differential cable pairs and/or fiber optics, each tailored to provide optimal performance for the data transmission needs. The dedicated differential cable pairs used in these interconnections may include a variety of cable media such as copper, aluminum, gold, silver, nickel, or composite materials like copper-clad aluminum, copper-clad steel, or bimetallic conductors. These materials may be chosen for their electrical conductivity and durability, ensuring reliable and efficient data transmission. For example, in a four-lane network, each lane may consist of its own dedicated copper cable, providing isolated physical paths for each communication lane of a deserialized data stream. This configuration helps in maintaining signal integrity and reducing crosstalk between lanes.

Alternatively, fiber optic cables may be employed for the interconnections. Fiber optics are capable of transmitting data streams via different wavelengths of light, with each data stream assigned a unique wavelength. The use of fiber optic cables may allow multiple data streams to be transmitted simultaneously through a single fiber optic cable, significantly increasing the bandwidth and efficiency of the network, and particularly advantageous for long-distance data transmission and for applications requiring high data transfer rates. Various optical networking technologies can be used to transmit multiple optical signals (e.g., data signals or data streams) over a single optical fiber within an optical link with little to no optical signal interference. These technologies may be used to improve bandwidth efficiency and reduce the amount of infrastructure needed for data communication. FIG. 2 illustrates a computer network topology that may be used in a data center. The illustrated computer network shows a multi-root tree topology, but it should be understood that other types of network topology are also contemplated, including fat tree and DCell network topologies.

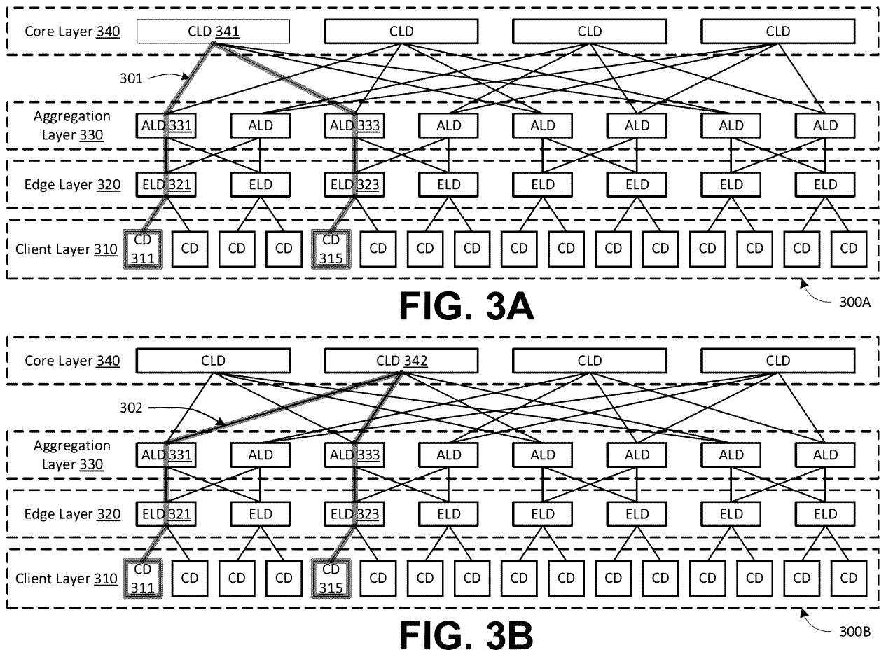

FIGS. 3A-3D illustrate example networking paths in the fat tree topology 200 of FIG. 2 described above, according to some aspects of the disclosure. As described above, a network path refers to a possible route that a data packet takes from a source device (e.g., a sender device) to a destination device (e.g., receiver device) within a network. The actual path of the data packet is influenced by physical and logical structure of the network, routing protocols, and algorithms for traffic flow management in the network.

As similarly described above, the example fat-tree topologies in FIGS. 3A-D can include a client layer 310 with client devices (e.g., client devices CD 311, 315), an edge layer 320 with edge layer devices (e.g., edge layer devices ELD 321, 323), an aggregation layer 330 with aggregation layer devices (e.g., aggregation layer devices ALD 331, 332, 333, 334), and a core layer 340 with core layer devices (e.g., core layer devices CLD 341, 342, 343, 344).

In some embodiments, data packets can be sent along the networking paths 301, 302, 303, 304 from the client device CD 311 (e.g., as a sender or source device) to the client device CD 315 (e.g., as a receiver or destination device). In some embodiments, data packets can be sent along the networking path 301 from the client device CD 315 (e.g., as a sender or source device) to the client device CD 311 (e.g., as a receiver or destination device).

FIG. 3A illustrates an example networking path 301 between client devices CD 311 and CD 315 of the client layer 310 in a fat-tree network topology 300A, according to some aspects of the disclosure. The networking path 301 connects the client device CD 311 to the edge layer device ELD 321. The edge layer device ELD 321 is connected to the aggregation layer device ALD 331. The aggregation layer device ALD 331 is connected to the core layer device CLD 341. The core layer device CLD 341 is connected to both the aggregation layer device ALD 331 and the aggregation layer device ALD 333. The aggregation layer device ALD 333 is connected to the edge layer device ELD 323. The edge layer device ELD 323 is connected to the client device CD 315.

FIG. 3B illustrates an example networking path 301 between client devices CD 311 and CD 315 of the client layer 310 in a fat-tree network topology 300B, according to some aspects of the disclosure. The networking path 302 connects the client device CD 311 to the edge layer device ELD 321. The edge layer device ELD 321 is connected to the aggregation layer device ALD 331. The aggregation layer device ALD 331 is connected to the core layer device CLD 342. The core layer device CLD 342 is connected to both the aggregation layer device ALD 331 and the aggregation layer device ALD 333. The aggregation layer device ALD 333 is connected to the edge layer device ELD 323. The edge layer device ELD 323 is connected to the client device CD 315.

FIG. 3C illustrates an example networking path 303 between client devices CD 311 and CD 315 of the client layer 310 in a fat-tree network topology 300C, according to some aspects of the disclosure. The networking path 302 connects the client device CD 311 to the edge layer device ELD 321. The edge layer device ELD 321 is connected to the aggregation layer device ALD 332. The aggregation layer device ALD 332 is connected to the core layer device CLD 343. The core layer device CLD 343 is connected to both the aggregation layer device ALD 332 and the aggregation layer device ALD 334. The aggregation layer device ALD 334 is connected to the edge layer device ELD 323. The edge layer device ELD 323 is connected to the client device CD 315.

FIG 3D illustrates an example networking path 304 between client devices CD 311 and CD 315 of the client layer 310 in a fat-tree network topology 300D, according to some aspects of the disclosure. The networking path 302 connects the client device CD 311 to the edge layer device ELD 321. The edge layer device ELD 321 is connected to the aggregation layer device ALD 332. The aggregation layer device ALD 332 is connected to the core layer device CLD 343. The core layer device CLD 344 is connected to both the aggregation layer device ALD 332 and the aggregation layer device ALD 334. The aggregation layer device ALD 334 is connected to the edge layer device ELD 323. The edge layer device ELD 323 is connected to the client device CD 315.

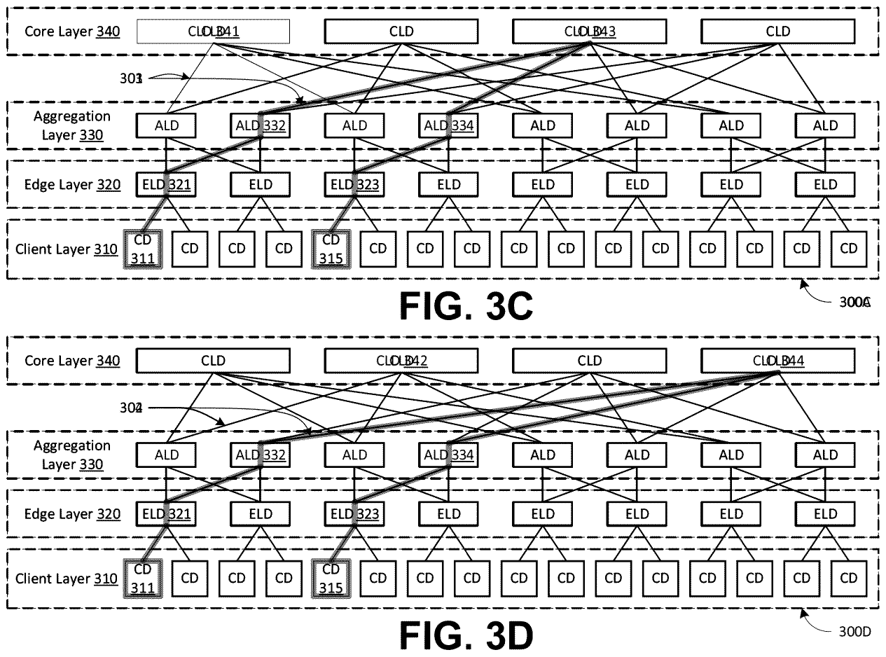

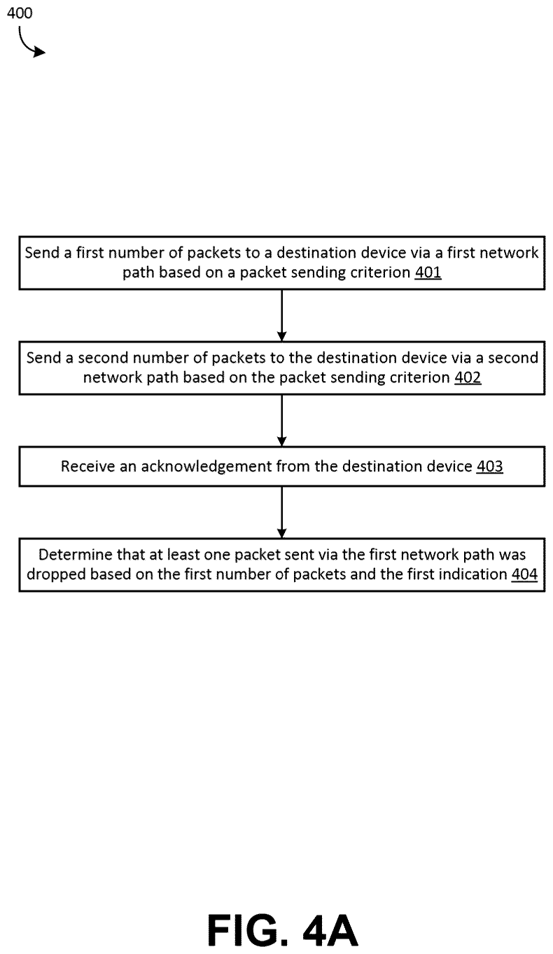

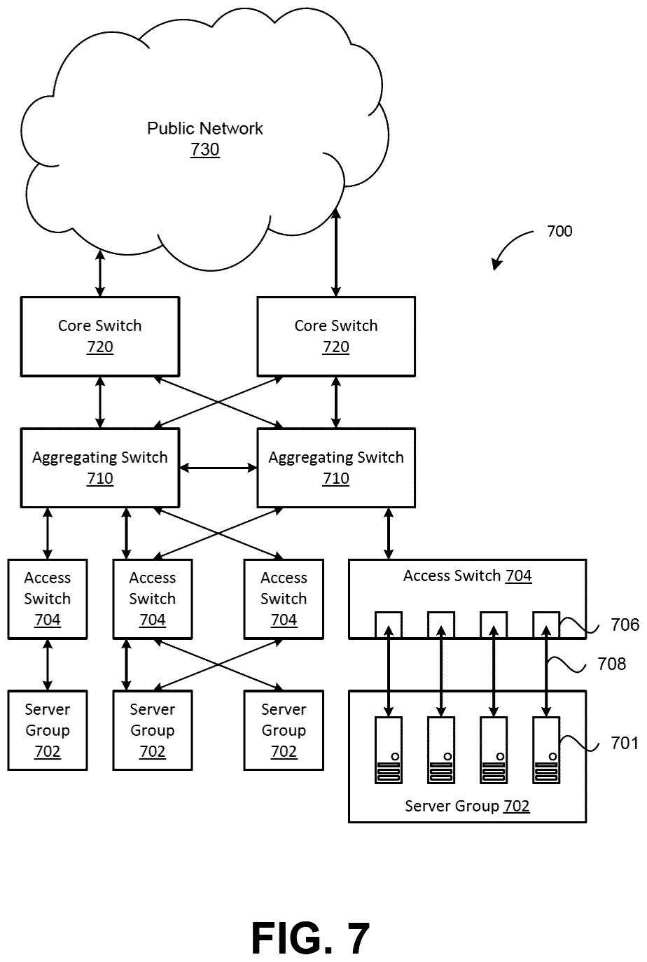

FIG. 4A is a flow diagram of an example method 400 for stateless packet loss detection in a network, according to aspects of the disclosure. The method 400 can be performed by control logic that may include hardware (e.g., processing device, circuitry, dedicated logic, programmable logic, microcode, hardware of a device, integrated circuit, etc.), software (e.g., instructions run or executed on a processing device), or a combination thereof. In some embodiments, a portion of the method 400 is performed by one of the network devices 104, 112 of FIGS. 1A-B, one of the client devices (CD) of FIG. 2, and/or processing circuitry, control logic, or a processor as described herein below with reference to FIGS. 7A-B. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

At operation 401, the control logic sends a first number of packets to a destination device via a first network path.

At operation 402, the control logic sends a second number of packets to the destination device via a second network path. In some embodiments, the first number of packets and the second number of packets are in a group of packets that are sent to the destination device. In some embodiments, the group of packets to be sent are sequentially numbered. In some embodiments, the packets are numbered based on a sequential transmission to the destination device.

In some embodiments, the control logic determines the packet sending criterion based on the plurality of packets. For example, the plurality of packets may have a sequential sending order, may include different data types, or groups of packets may be associated with respective processes. The packet sending criterion can be predetermined by the control logic prior to sending packets to the destination device. In some embodiments, the packet sending criterion is predetermined during manufacturing of the device. In some embodiments, the packet sending criterion is configured in software/firmware/hardware, or the like, and may be adjusted.

At operation 403, the control logic receives an acknowledgment from the destination device. The acknowledgement includes an indication that one or more packets of the first set of packets arrived at the destination device.

At operation 404, the control logic determines that at least one packet sent via the first network path was dropped based on the first number of packets and the first indication. In some embodiments, responsive to determining that the at least one packet sent via the first network path was dropped, the control logic determines a first connectivity status of the first network path. In some embodiments, the first connectivity status can reflect a network path health, or reliability. For example, the first connectivity status can reflect a percentage of received packets versus sent packets.

In some embodiments, to determine that at least one packet sent via the first network path was dropped, the control logic is to determine that the first number of packets that arrived at the destination device satisfy a first threshold. In some embodiments, the first threshold is based on the first number of packets. In some embodiments, the first threshold represents a quantity of the first number of packets. In some embodiments, the last packet of the first number of packets is not received at the destination device, and a value of the first threshold matches a first number of packets minus one. That is, in some embodiments, the last packet may not have been received when the control logic performs the check. In such embodiments, if all other packets in the first number of packets have been received (e.g., the number of packets minus 1), then received packets can satisfy the first threshold.

FIG. 4B is a flow diagram of an example method 450 for stateless packet loss detection in a network, according to aspects of the disclosure. The method 450 can be performed by control logic that may include hardware (e.g., processing device, circuitry, dedicated logic, programmable logic, microcode, hardware of a device, integrated circuit, etc.), software (e.g., instructions run or executed on a processing device), or a combination thereof. In some embodiments, a portion of the method 450 is performed by one of the network devices 104, 112 of FIGS. 1A-B, one of the client devices (CD) of FIG. 2, and/or processing circuitry, control logic, or a processor as described herein below with reference to FIGS. 7A-B. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

At operation 451, the control logic performing the method 450 obtains a plurality of packets to be sent to one or more receiver devices via a plurality of network paths based on a packet transmission schema, wherein the packet transmission schema indicates a first set of packets of the plurality of packets are to be sent via a first network path of the plurality of network paths and a second set of packets of the plurality of packets are to be sent via a second network path of the plurality of network paths.

In some embodiments, the data packets are sequentially numbered with a packet sequence number (PSN). In some embodiments, each packet receives a PSN when it is sent by a sending device, and thus each packet sent by the sending device may be sent sequentially. Thus, each packet sent by the sending device can be sequentially numbered by a set of sequential numbers. Accordingly, in some embodiments, a first set of packets can be associated with a first subset of packet sequence numbers, a second set of packets associated with a second subset of packet sequence numbers, and so on. That is, a highest packet number (e.g., PSN 10) of a first subset of packet sequence numbers (e.g., PSNs 1-10) can be less than a lowest packet number (e.g., PSN 11) of a second subset of packet sequence numbers (e.g., PSN 11-20). In some embodiments, the PSN numbers for each packet may be assigned based on data types, a predetermined algorithm or the like.

When a receiving device receives a set of packets, the PSNs of the received set of packets (e.g., a third set of packets) can correspond to the PSNs of the sent set of packets (e.g., a first set of packets). In some embodiments, the control logic can determine whether the received set of packets satisfies a first threshold based on the first subset of packet sequence numbers. For example, if packets having PSNs 1-10 are sent to a device, and the receiving device receives packets having PSNs 1-4, 6-9, then it may be determined that at least the packet with the PSN 5 was lost. In some embodiments, if a packet with the last PSN of the subset of PSNs for the set of packets is not received (e.g., a packet with PSN 10 for the packets having PSNs 1-10), it may be unknown whether the last packet was received, or is still in transit. In some embodiments, once another set of packets are sent via the same network path (e.g., packets having PSNs 101-110), and the last packet of the first set is not received, the control logic may increase a risk factor reflecting that the last packet of the first set of packets (e.g., the packet with PSN 10) was not delivered/received at the destination device. However, since each network path is independent, the increased risk factor does not definitively indicate that the last packet will not be received.

In some embodiments, the control logic determines, based on the plurality of packets, the packet transmission schema. For example, the packet transmission schema can be to send packets with a first data type on a first network path and packets with a second data type on a second network path. In another example, the packet transmission schema can be to send a predetermined number of packets on the first network path, then send the predetermined number of packets on the second network path, and the predetermined number of packets on the third network path and so on. In another example, the packet transmission schema can be to send a first predetermined number of packets on the first network path, and a second number of predetermined backets on the second network path and so on. That is, there can be different predetermined numbers of packets that are sent. The predetermined number of packets to send on each path can be based on an algorithm, a pseudo-random algorithm, a predetermined pattern, or the like. In some embodiments, each path can be associated with a predetermined number of packets. That is, the first network path can be associated with a first number of packets, the second path with a second number of packets, a third path with a third number of packets, and so on.

In some embodiments, the control logic selects which network path based on predetermined algorithms and/or patterns. In some embodiments, network paths are selected based on network traffic. In some embodiments, packets may be sent along multiple paths simultaneously.

At operation 452, the control logic sends the first set of packets via the first network path.

At operation 453, the control logic receives at least one acknowledgement message from the one or more receiver devices, wherein the acknowledgement message comprises a first indication that a third set of packets was received at the one or more receiver devices.

At operation 454, the control logic determines that the third set of packets satisfies a first criterion of the packet transmission schema. In some embodiments, to determine that the third set of packets satisfies the first criterion, the control logic determines that the third set of packets satisfies a first threshold based on the first set of packets. Responsive to determining the third set of packets satisfies the first threshold, the control logic indicates that the third set of packets satisfies the first criterion.

In some embodiments, the first threshold is based on whether a last transmitted packet has been received. Since packets are sent sequentially and include a packet sequence number (PSN), any packets with a smaller PSN number than a last-received packet that were sent over the same network path can be considered lost packets. For example, if a receiving device receives packets with PSNs 1-8, and PSN 10, and the sending device sent packets with PSNs 1-10 on the first network path, PSN 9 can be considered lost. In some embodiments, the sending device is agnostic as to what packet is lost, or even the PSN value of the packet(s) that was (were) lost. For this metric related to stateless packet loss detection, the sending device may only need to know a percentage of the number of packets received versus the number of packets sent. In some embodiments, to determine that a received set of packets (e.g., a “third set of packets”) satisfies the first threshold, the control logic determines that the third number of packets matches a first number of packets (e.g., a number of packets sent via the same network path). In some embodiments, the control logic can determine loss rate of the network path based on the number of sent packets (e.g., first number of packets) and the number of received packets (e.g., third number of packets).

At operation 455, responsive to determining that the third set of packets satisfies the first criterion, the control determines a first connectivity status of the first network path, the first connectivity status indicating a first packet loss rate for the first network path. In some embodiments, the first connectivity status reflects a percentage of received packets over sent packets. For example, if eight packets have been received and ten packets were sent via the first network path, the first connectivity status can reflect a 80% packet transmission rate. In some embodiments, the first connectivity status reflects a binary pass/fail for packet transmission over the first network path. That is, the first connectivity status may reflect a pass if 100% of transmitted packets are received and a fail if less than 100% of transmitted packets are received. In some embodiments, a connectivity criterion can be predetermined based on transmission requirements for the network. In some embodiments, the connectivity criterion can be specific to a specific network path. In some embodiments, the connectivity criterion is used for all network paths in a network.

In some embodiments, the control logic can send the second set of packets via the second network path. The acknowledgement message can further include a second indication that a fourth set of packets were received. The control logic can determine that the fourth set of packets do not satisfy a second criterion of the packet transmission schema. Responsive to determining that the fourth set of packets do not satisfy the second criterion, the control logic determines a second connectivity status of the second network path. The second network connectivity status indicates a second packet loss rate for the second network path.

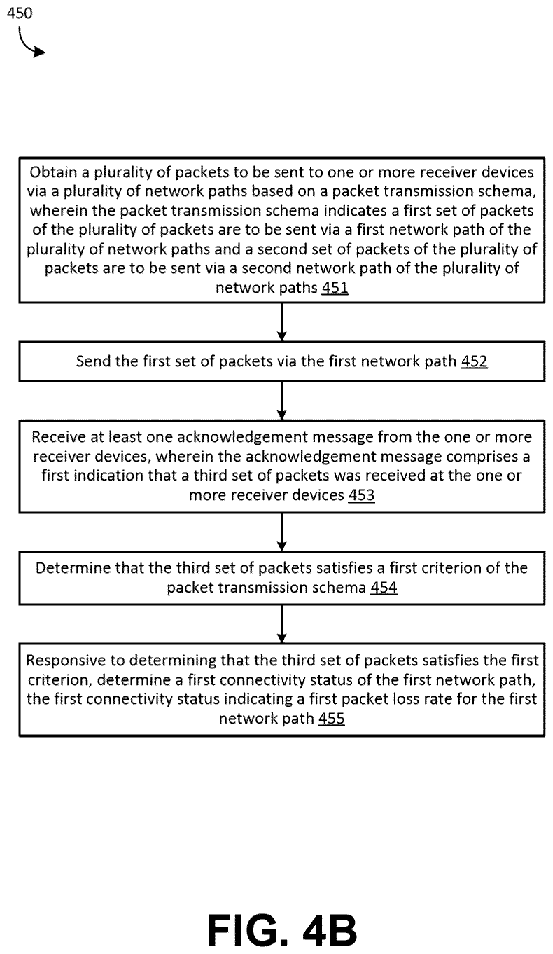

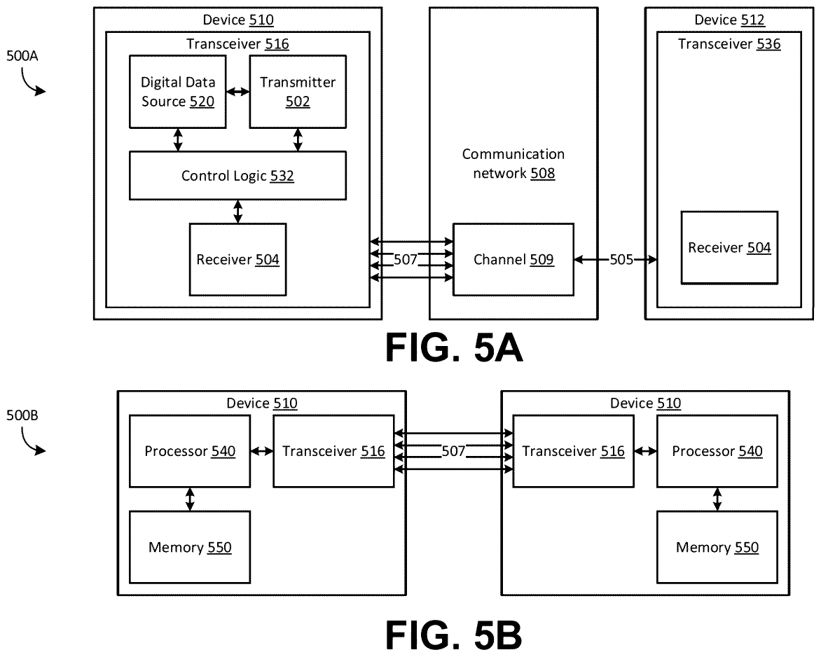

FIG. 5A illustrates an example communication system 500A, according to some aspects of the disclosure. The system 500A includes a device 510, a communication network 508 including a communication channel 509, and a device 512. In at least one embodiment, devices 510 and 512 are two end-point devices in a computing system, such as a central processing unit (CPU) or graphics processing unit (GPU).

In at least one embodiment, devices 510 and 512 are two servers. In at least one example embodiment, devices 510 and 512 correspond to one or more of a Personal Computer (PC), a laptop, a tablet, a smartphone, a server, a collection of servers, or the like. In some embodiments, the devices 510 and 512 may correspond to any appropriate type of device that communicates with other devices connected to a common type of communication network 108. In embodiments, the transmitter 502 of the device 510 can correspond to transmitters of a graphics processing unit (GPU), a switch (e.g., a high-speed network switch), a network adapter, a central processing unit (CPU), a data processing unit (DPU), etc. In embodiments, each of devices 510 and 512 may comprise one or more processing circuits, as detailed above; the processing circuits may comprise firmware that is loaded onto the processing circuits during production of the device 510 and 512.

According to embodiments, the receiver 504 of devices 510 or 512 may correspond to a GPU, a switch (e.g., a high-speed network switch), a network adapter, a CPU, a memory device, an input/output (I/O) device, other peripheral devices or components on a system-on-chip (SoC), or other devices and components at which a signal is received or measured, etc. As another specific but non-limiting example, the devices 510 and 512 may correspond to servers offering information resources, services, and/or applications to user devices, client devices, or other hosts in the system 500A.

In one example, devices 510 and 512 may correspond to network devices such as switches, network adapters, or data processing units (DPUs). The device 510 includes a transceiver 516 for sending and receiving signals, for example, data signals. The data signals may be digital or optical signals modulated with data or other suitable signals for carrying data.

The transceiver 516 may include a digital data source 520, a transmitter 502, a receiver 504, and control logic 532 (e.g., processing circuitry) that controls the transceiver 516. The digital data source 520 may include suitable hardware and/or software for outputting data in a digital format (e.g., in binary code and/or thermometer code). The digital data output by the digital data source 520 may be retrieved from memory (not illustrated) or generated according to input (e.g., user input).

The transmitter 502 includes suitable software and/or hardware for receiving digital data from the digital data source 520 and outputting data signals according to the digital data for transmission over the communication network 508 to a receiver 504 of device 512.

The receiver 504 of devices 510 and 512 may include suitable hardware and/or software for receiving signals, such as data signals from the communication network 508. For example, the receiver 504 may include components for receiving optical signals.

The control logic 532 may comprise software, hardware, or a combination thereof. For example, the control logic 532 may include a memory including executable instructions and a processor (e.g., a microprocessor) that executes the instructions on the memory. The memory may correspond to any suitable type of memory device or collection of memory devices configured to store instructions. Non-limiting examples of suitable memory devices that may be used include Flash memory, Random Access Memory (RAM), Read Only Memory (ROM), variants thereof, combinations thereof, or the like. In some embodiments, the memory and processor may be integrated into a common device (e.g., a microprocessor may include integrated memory).

Additionally, or alternatively, the control logic 532 may comprise hardware, such as an application-specific integrated circuit (ASIC). Other non-limiting examples of the control logic 532 include an Integrated Circuit (IC) chip, a Central Processing Unit (CPU), a General Processing Unit (GPU), a microprocessor, a Field Programmable Gate Array (FPGA), a collection of logic gates or transistors, resistors, capacitors, inductors, diodes, or the like.

Some or all of the control logic 532 may be provided on a Printed Circuit Board (PCB) or collection of PCBs. It should be appreciated that any appropriate type of electrical component or collection of electrical components may be suitable for inclusion in the control logic 532. The control logic 532 may send and/or receive signals to and/or from other elements of the transceiver 516 to control the overall operation of the transceiver.

In embodiments, each of devices 510 and 512 may comprise one or more processing circuits, as detailed above; the processing circuits may comprise FW, that is loaded according to the techniques described above.

In embodiments, the devices 510 can be connected via a parallel fiber interface 507 to a channel 509 of the communication network. That is, the transmitter 502 can output multiple optical signals on a parallel fiber interface 507. The channel 509 can include an optical shuffle box as described herein above, and can be received by the transceiver 536 via a single optical fiber 505, as illustrated.

FIG. 5B is a block diagram that schematically illustrates a communication system 500B, according to some aspects of the disclosure. The communication system 500B comprises two devices 510 that are configured to exchange electronic communications (e.g., packet-based communications) with one another over a parallel fiber interface 507. The parallel fiber interface 507 may include or be part of a communication network 508. In some embodiments, signals are sent via the parallel fiber interface 507 by a transceiver (e.g., transceiver 516 or transceiver 536) into an optical shuffle box, which provides an output of a single optical fiber.

Illustratively, but without limitation, the communication devices 510 may correspond to network devices, such as network device 104 or network device 112 of FIG. 1. As such, the communication devices 510 may correspond to any type of device that becomes part of or is connected with a communication network. Examples of suitable devices that may act or operate like a device 510 as described herein include, without limitation, one or more of a Personal Computer (PC), a laptop, a tablet, a smartphone, a server, a collection of servers, a networking card, an edge router, a switch, Network Interface Cards, a Top of Rack (ToR) switch, a server blade, or the like. As will be described in further detail herein, the device 510 may include a transceiver 516, a processor 540 (or one or more processors 540), and memory 550. The transceiver 516 may include hardware that enables communications over the parallel fiber interface 507 whereas the processor 540 and memory 550 may include components that enable the device 510 to provide a desired functionality or perform certain functions.

The parallel fiber interface 507 may traverse a datacenter or any type of communication network (whether trusted or untrusted). Examples of a communication network that may be used to connect communication devices 510 and support the parallel fiber interface 507 include, without limitation, an Internet Protocol (IP) network, an Ethernet network, an InfiniBand (IB) network, a Fibre Channel network, the Internet, a cellular communication network, a wireless communication network, combinations thereof (e.g., Fibre Channel over Ethernet), variants thereof, and/or the like. In one specific, but non-limiting example, the communication network enables data transmission between the communication devices 510 using optical signals. In this case, the communication devices 510 and the communication network may include waveguides (e.g., optical fibers) that carry the optical signals.

The transceiver 516 may include electrical components, optical components, or combinations thereof that facilitate communications over the parallel fiber interface 507. The components of the transceiver 516 may be coupled to the processor 540. Data, electrical signals, or the like may be exchanged between the transceiver 516 and processor 540. In some embodiments, the processor 540 may utilize the transceiver 516 to transmit data packets to a remote device 510 via the parallel fiber interface 507. Similarly, data packets received at a transceiver 516 may be decoded by the transceiver 516 and provided to the processor 540 coupled therewith. In some embodiments, the processor 540 may utilize instructions stored in memory 550 to facilitate operations of the device 510.

The processor 540 may be or include one or more of an Integrated Circuit (IC) chip, a microprocessor, a Central Processing Unit (CPU), a Graphics Processing Unit (GPU), a Data Processing Unit (DPU), a Field Programmable Gate Array (FPGA), an Application Specific Integrated Circuit (ASIC), combinations thereof, and the like.

The memory 550 may include any number of memory devices, any type of memory device, any combination of different types of memory devices, etc. As an example, the memory 550 may include Random Access Memory (RAM), Read Only Memory (ROM), flash memory, Electronically-Erasable Programmable ROM (EEPROM), Dynamic RAM (DRAM), buffer memory, combinations thereof, and the like.

In embodiments, each of communication devices 510 may comprise one or more processing circuits, as detailed above; the processing circuits may comprise FW, that is loaded according to the techniques described above.

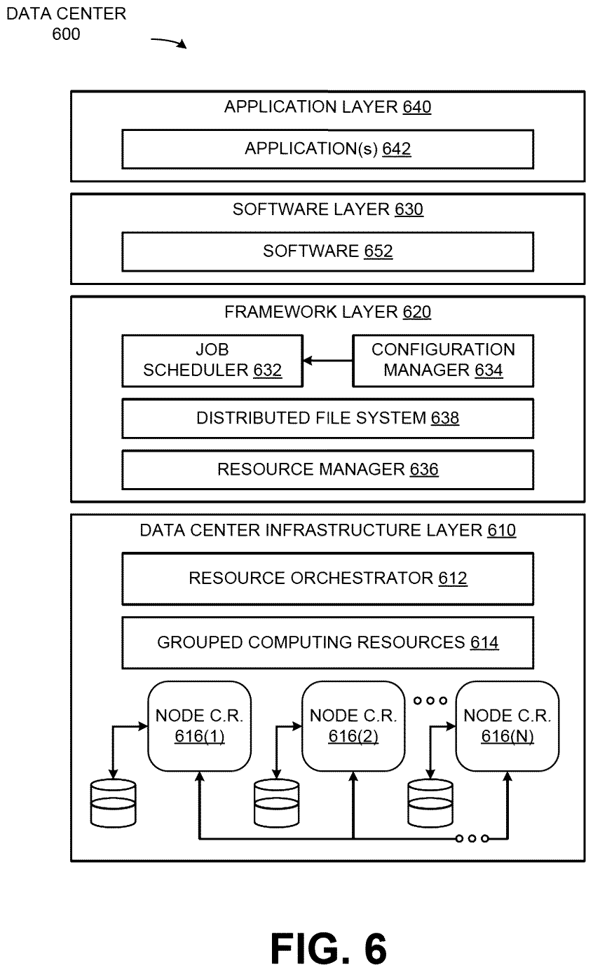

FIG. 6 illustrates an exemplary data center 600, according to some aspects of the disclosure. In at least one embodiment, data center 600 includes, without limitation, a data center infrastructure layer 610, a framework layer 620, a software layer 630 and an application layer 640.

In at least one embodiment, as shown in FIG. 6, data center infrastructure layer 610 may include a resource orchestrator 612, grouped computing resources 614, and node computing resources (“node C.R.s”) 616(1)-616(N), where “N” represents any whole, positive integer. In at least one embodiment, node C.R.s 616(1)-216(N) may include, but are not limited to, any number of central processing units (“CPUs”) or other processors (including accelerators, field programmable gate arrays (“FPGAs”), graphics processors, etc.), memory devices (e.g., dynamic read-only memory), storage devices (e.g., solid state or disk drives), network input/output (“NW I/O”) devices, network switches, virtual machines (“VMs”), power modules, and cooling modules, etc. In at least one embodiment, one or more node C.R.s from among node C.R.s 616(1)-616(N) may be a server having one or more of above-mentioned computing resources.

In at least one embodiment, grouped computing resources 614 may include separate groupings of node C.R.s housed within one or more racks (not shown), or many racks housed in data centers at various geographical locations (also not shown). Separate groupings of node C.R.s within grouped computing resources 614 may include grouped compute, network, memory or storage resources that may be configured or allocated to support one or more workloads. In at least one embodiment, several node C.R.s including CPUs or processors may be grouped within one or more racks to provide compute resources to support one or more workloads. In at least one embodiment, one or more racks may also include any number of power modules, cooling modules, and network switches, in any combination.

In at least one embodiment, resource orchestrator 612 may configure or otherwise control one or more node C.R.s 616(1)-616(N) and/or grouped computing resources 614. In at least one embodiment, resource orchestrator 612 may include a software design infrastructure (“SDI”) management entity for data center 600. In at least one embodiment, resource orchestrator 612 may include hardware, software or some combination thereof.

In at least one embodiment, as shown in FIG. 6, framework layer 620 includes, without limitation, a job scheduler 632, a configuration manager 634, a resource manager 636 and a distributed file system 638. In at least one embodiment, framework layer 620 may include a framework to support software 652 of software layer 630 and/or one or more applications 642 of application layer 640. In at least one embodiment, software 652 or applications 642 may respectively include web-based service software or applications, such as those provided by Amazon Web Services, Google Cloud and Microsoft Azure. In at least one embodiment, framework layer 620 may be, but is not limited to, a type of free and open-source software web application framework such as Apache Spark™ (hereinafter “Spark”) that may utilize distributed file system 638 for large-scale data processing (e.g., “big data”). In at least one embodiment, job scheduler 632 may include a Spark driver to facilitate scheduling of workloads supported by various layers of data center 600. In at least one embodiment, configuration manager 634 may be capable of configuring different layers such as software layer 630 and framework layer 620, including Spark and distributed file system 638 for supporting large-scale data processing. In at least one embodiment, resource manager 636 may be capable of managing clustered or grouped computing resources mapped to or allocated for support of distributed file system 638 and job scheduler 632. In at least one embodiment, clustered or grouped computing resources may include grouped computing resource 614 at data center infrastructure layer 610. In at least one embodiment, resource manager 636 may coordinate with resource orchestrator 612 to manage these mapped or allocated computing resources.

In at least one embodiment, software 652 included in software layer 630 may include software used by at least portions of node C.R.s 616(1)-616(N), grouped computing resources 614, and/or distributed file system 638 of framework layer 620. One or more types of software may include, but are not limited to, Internet web page search software, e-mail virus scan software, database software, and streaming video content software.

In at least one embodiment, applications 642 included in application layer 640 may include one or more types of applications used by at least portions of node C.R.s 616(1)-616(N), grouped computing resources 614, and/or distributed file system 638 of framework layer 620. In at least one or more types of applications may include, without limitation, CUDA applications, 5G network applications, artificial intelligence application, data center applications, and/or variations thereof.

In at least one embodiment, any of configuration manager 634, resource manager 636, and resource orchestrator 612 may implement any number and type of self-modifying actions based on any amount and type of data acquired in any technically feasible fashion. In at least one embodiment, self-modifying actions may relieve a data center operator of data center 600 from making possibly bad configuration decisions and possibly avoiding underutilized and/or poor performing portions of a data center.

FIG. 7 illustrates an example datacenter 700, according to some aspects of the disclosure. In a datacenter that includes a variety of computing resources, there may be a number of distinct servers that perform data processing workloads. For example, the data center may include a number of racks, and each rack may include a number of distinct servers 701. Each server 701 may have a connection to a data center network, which may provide communication links between the servers 701 and between individual servers 701 and a central coordinating server. The servers 701 may be organized into server groups 702, for example with all of the servers in a single rack being in a single group. Any appropriate grouping of servers 701 may be used.

Each of the server groups 702 may be connected to the data center network by an access switch 704. The access switch 704 includes ports 706, by which a physical medium 708 connects respective servers 701 to the access switch 704. The physical medium 708 may be any appropriate medium, such as twisted pair cables, coaxial cables, and optical fiber cables. The physical media 708 provide bidirectional communications, so that the servers 702 can send data to, and receive data from, the access switch 704. Any appropriate number of servers 701 may connect to a single access switch 704, limited by the number of physical ports 706 that the access switch 704. Additionally, individual servers 701 may be connected to multiple access switches 704 for redundancy.

In at least some embodiments, the access switches 704 may receive information on any of its physical ports 706 and may direct that information to one or more of its physical ports 706 in accordance with an intended destination of that information. For example, a first server in the network may transmit data intended for a second server in the network, with both the first server and the second server being connected by a physical medium 708 to a same access switch 704. The access switch 704 may identify the destination for the data and may transmit that data on the physical medium 708 corresponding to the second server, without retransmitting the data to other servers that may be connected to the access switch 704.

Multiple access switches 704 may, in turn, be connected to aggregating switches 710 on an aggregating layer of the network topology. The aggregating switches 710 may have a similar structure to the access switches 704, with physical media connecting a port 706 of each access switch 704 to a port of a respective aggregating switch 710. In at least some embodiments, the aggregating switches 710 may connect to one another as well. Additionally, multiple access switches 704 may be connected to multiple aggregating switches 710 for redundancy.

During operation, the aggregating switches 710 may transmit information between different access switches 704. For example, if a first server 701 is connected to a first access switch 704 and transmits information that is destined for a second server 701 on a second access switch 704, then the first access switch may transmit the information to an aggregating switch 710 that is connected to both access switches 704. The second access switch 704 then identifies the port belonging to the second server 701 and transmits the information to its destination.

In at least some embodiments, the access switches 704 and the aggregating switches 710 establish a hierarchical structure that provides network connectivity to all of the servers 701 within a data center. In at least some embodiments, a layer of core switches 720 may be used to provide an interface between the data center network and a public network 730. The core switches 720 may operate as switches that connect the aggregating switches 710 to one another and may also route information to and from the Internet.

Each of the switches described herein, including the access switches 704, the aggregating switches 710, and the core switches 720, may be managed switches. A managed switch provides the network administrator with tools to control the operation of the switch, including changing the settings of individual ports 706. For example, the administrator may use the managed switch to control quality of service settings by ensuring that certain ports have access to a specified amount of bandwidth. In another example, the administrator may configure ports to provide link aggregation, whereby a single device may connect to a switch by multiple ports 706 to multiply its bandwidth.

### Computing Systems

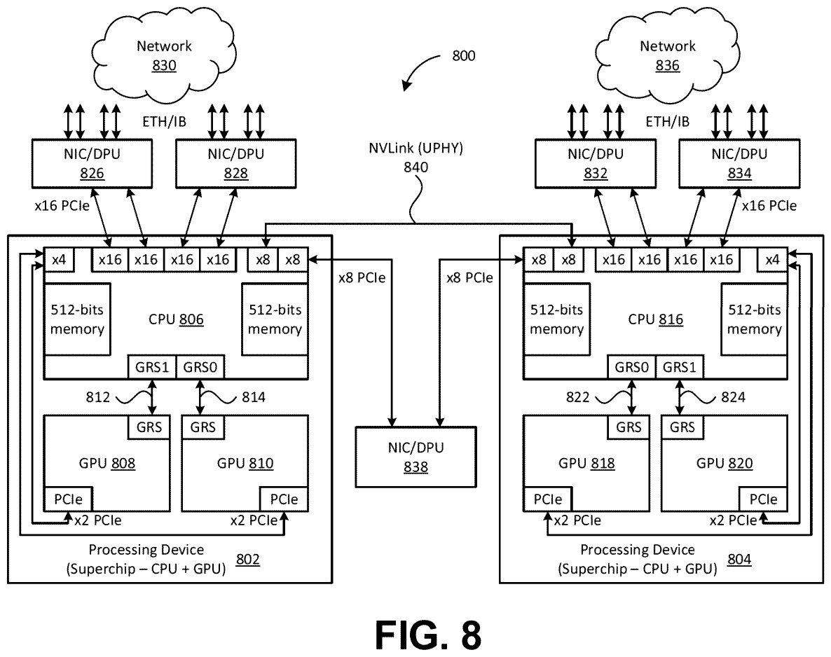

FIG. 8 is a block diagram of a computing system 800 having two processing devices coupled to each other and multiple networks according to some aspects of the disclosure. The computing system 800 is designed with multiple integrated circuits (referred to as processing devices), where each integrated circuit includes a CPU and two GPUs, forming a powerful and flexible architecture. These processing devices are interconnected via an NVLink (or other high-speed interconnect), enabling high-speed communication between the processing devices, and are also connected through a NIC or DPU to ensure efficient data transfer across the computing system 800.

The coupling of processing devices through NVLink allows for seamless data exchange and parallel processing, enhancing overall computational performance. Additionally, these processing devices are connected to multiple networks through one or more NICs or DPUs, enabling the system to handle complex, multi-network tasks with high bandwidth and low latency. This configuration makes the computing system 800 highly suitable for demanding applications that require significant processing power, such as artificial intelligence (AI), machine learning (ML), and data-intensive computing, while ensuring robust connectivity and scalability across various networked environments. The integrated circuits of the computing system 800 can include one or more CPUs and one or more GPUs. An example architecture of a multi-GPU architecture is illustrated in FIG. 8.

As illustrated in FIG. 8, the computing system 800 includes a processing device 802 with a multi-GPU architecture. In particular, the processing device 802 includes a CPU 806, a GPU 808, and a GPU 810. The CPU 806 can be coupled to the GPU 808 via an die-to-die (D2D) or chip-to-chip (C2C) interconnect 812, such as a Ground-Referenced Signaling interconnect (GRS interconnect). The CPU 806 can be coupled to the GPU 810 via a D2D or C2C interconnect 814. The CPU 806 can also couple to the GPU 808 and GPU 810 via PCIe interconnects. The CPU 806 can be coupled to one or more NICs or DPUs, which are coupled to one or more networks. For example, as illustrated in FIG. 8, the CPU 806 is coupled to a first NIC/DPU 826, which is coupled to a network 830. The CPU 806 is also coupled to a second NIC/DPU 828, which is coupled to the network 830. The NIC/DPU 826 and NIC/DPU 828 can be coupled to the network 830 over Ethernet (ETH) or InfiniBand (IB) connections.

The computing system 800 also includes a processing device 804 with a multi-GPU architecture. In particular, the processing device 804 includes a CPU 816, a GPU 818, and a GPU 820. The CPU 816 can be coupled to the GPU 818 via an D2D or C2C interconnect 822. The CPU 816 can be coupled to the GPU 820 via a D2D or C2C interconnect 824. The CPU 816 can also couple to the GPU 818 and GPU 820 via PCIe interconnects. The CPU 816 can be coupled to one or more NICs or DPUs, which are coupled to one or more networks. For example, as illustrated in FIG. 8, the CPU 816 is coupled to a first NIC/DPU 832, which is coupled to a network 836. The CPU 816 is also coupled to a second NIC/DPU 834, which is coupled to the network 836. The NIC/DPU 832 and NIC/DPU 834 can be coupled to the network 836 over Ethernet (ETH) or InfiniBand (IB) connections.

In at least one embodiment, the processing device 802 and the processing device 804 can communication with each other via a NIC/DPU 838, such as over PCIe interconnects. The processing device 802 and processing device 804 can also communicate with each other over a high-bandwidth communication interconnects 840, such as an NVLink interconnect or other high-speed interconnects.

The computing system 800 includes various types of interconnects. In some embodiments, one or more of the interconnects includes one or more of the transceivers 516, 536 transceivers 516, 536 described above with reference to FIGS. 5A-5B.

In at least one embodiment, the computing system 800 is used for high-speed network communication and includes a processing unit (e.g., CPU 806, GPU 808, GPU 808, CPU 816, GPU 818, GPU 820, NIC/DPU 826, NIC/DPU 828, NIC/DPU 832, NIC/DPU 834, or NIC/DPU 838), and a network interface coupled to the processing unit. The network interface includes a transceiver circuit operatively coupled to a controller.

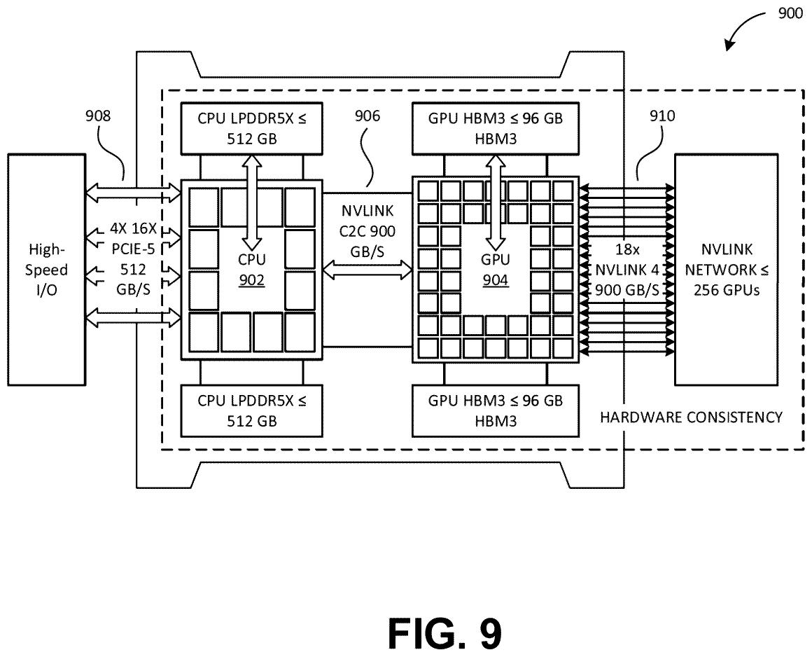

FIG. 9 is a block diagram of a computing system 900 having a CPU 902 and a GPU 904 in a single integrated circuit, according some aspects of the disclosure. The computing system 900 can be a highly integrated design where a CPU 902 and GPU 904 are connected on a single integrated circuit, utilizing an NVLink C2C (Chip-to-Chip) interconnect 906 to enable fast, low-latency communication between the two processing units. This close integration allows for efficient data transfer and parallel processing between the CPU 902 and GPU 904, optimizing performance for complex computational tasks. The GPU elements within the computing system 900 can be interconnected using an NVLink network, allowing for scalability to include multiple GPU elements (e.g., up to 256 as illustrated), creating a powerful, unified processing environment ideal for large-scale AI, ML, and high-performance computing applications. The NVLink network can be a GPU fabric of high-bandwidth communication interconnects 910. Additionally, the computing system 900 can be designed to interface with a high-speed I/O through PCIe interconnects 908, ensuring rapid data transfer to and from external devices, further enhancing the system's capabilities in handling data-intensive tasks and providing robust connectivity to peripheral components. It should be noted that the C2C interconnects 906 can be considered D2D interconnects since the CPU 902 and the GPU 904 are located on the same integrated circuit. The integrated circuit can include CPU memory (also referred to as main memory) and GPU memory, which are accessible by the CPU 902 and the GPU 904, respectively, over high-speed interconnects. The computing system 900 can bring together performance of the GPU 904 with the versatility of the CPU 902. The CPU 902 can be connected with a high-bandwidth and memory coherent C2C interconnects 906 in a single integrated circuit. The computing system 900 can support a link switch system.

The computing system 900 includes various types of interconnects. Each of the interconnects includes one or more of the transceivers 516, 536 described above with reference to FIGS. 5A-5B.

In at least one embodiment, the computing system 900 is used for high-speed network communication and includes a processing unit (e.g., CPU 902, GPU 904, NVLink network), and a network interface coupled to the processing unit. The network interface can include the controller as described above with respect to FIG. 8.

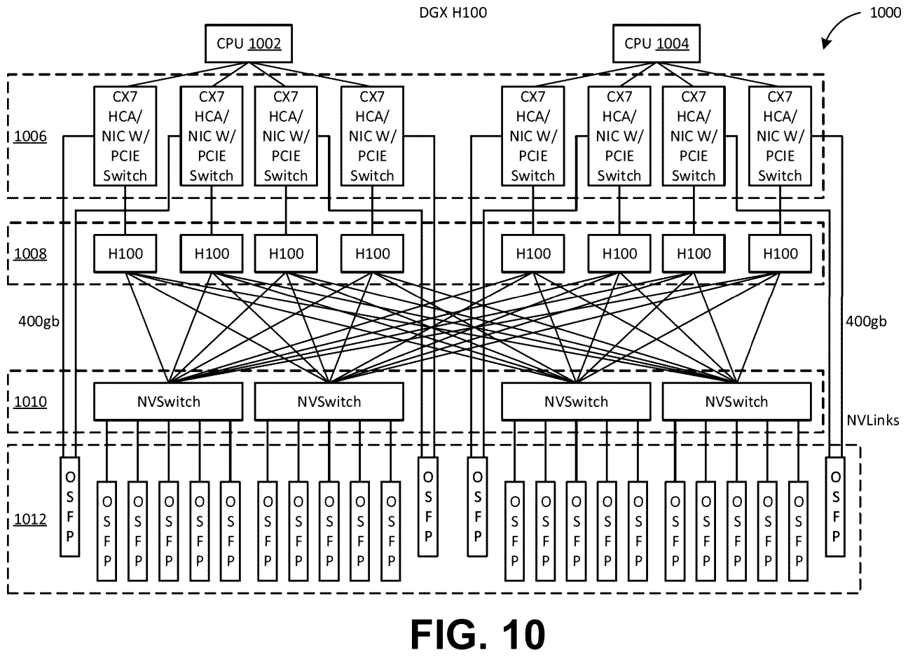

FIG. 10 is a block diagram of a computing system 1000 having tensor core GPUs 1008, according to some aspects of the disclosure. The computing system 1000 can be an NVIDIA© DGX H100 system which is a high-performance computing platform designed to meet the demands of AI, ML, and deep learning (DL) workloads. The computing system 1000 can include multiple tensor core GPUs 1008 (e.g., NVIDIA H100 Tensor Core GPUs). The tensor core GPUs 1008 can each be one of the integrated circuits described above with respect to FIG. 8. The tensor core GPUs 1008 can be optimized for AI/ML/DL applications, offering exceptional performance for deep learning training, inference, and high-performance computing tasks. The tensor core GPUs 1008 within the computing system 1000 are interconnected using high-speed communication interfaces like NVLinks, enabling rapid data transfer between them, which is crucial for handling large-scale AI models and datasets with low latency. This computing system 1000 is designed for scalability, allowing for the integration of additional GPUs as required, making it versatile enough for research, development, and deployment in data centers for production AI workloads. Each GPU is equipped with Tensor Cores, specialized processing units that accelerate matrix operations, a fundamental component of AI and deep learning algorithms. These Tensor Cores enable the system to perform mixed-precision calculations efficiently, balancing speed and accuracy. Given the power consumption and heat generation of multiple tensor core GPUs 1008, the computing system 1000 can include advanced cooling solutions and power management features to ensure safe operation while maintaining peak performance. It is supported by a comprehensive software ecosystem, including NVIDIA's CUDA programming model, AI frameworks like TensorFlow and PyTorch, and other HPC and AI software tools, which enable developers and researchers to harness the full power of the tensor core GPUs 1008 for their specific applications. The computing system 1000 is ideally suited for large-scale AI model training, real-time inference, scientific simulations, data analytics, and other compute-intensive tasks that require massive parallel processing power.

The tensor core GPUs 1008 can be coupled to multiple CPUs, such as CPU 1002 and CPU 1004, using switches 1006 (e.g., CX7 HCA/NIC with PCIe switch). The tensor core GPUs 1008 can be coupled to each other via switches 1010 (e.g., NV-Switches). The switches 1006 and switches 1010 can be coupled to high-speed transceiver modules 1012. The high-speed transceiver modules 1012 can be Octal Small Form-factor Pluggable (OSFP) modules. OSFP modules refer to high-speed transceiver modules designed for rapid data communication, particularly in environments requiring significant bandwidth, such as data centers and high-performance computing systems. These modules support extremely high data rates, typically up to 800 Gbps per module, with future capabilities extending to 1600 Gbps or more. OSFP modules interface with the system via the PCIe interface, enabling fast and efficient data transfer between the integrated CPU-GPU components and external networks or other connected systems. Their hot-pluggable nature allows for easy insertion or removal without the need to power down the system, offering flexibility and ease of maintenance, which is crucial in critical-uptime environments. Additionally, OSFP modules are designed for high density, maximizing the number of high-speed connections within limited space, such as in densely packed server racks. By adhering to the latest networking standards, OSFP modules ensure the computing system 1000 remains capable of meeting increasing data demands and can be upgraded to support future advancements in network speeds, thus contributing to the system's overall performance and scalability.

In at least one embodiment, the computing system 1000 can be considered a data-network configuration with full-bandwidth intra-server NVLinks. In this example, all eight tensor core GPUs 1008 can simultaneously saturate eighteen NVLinks to other GPUs within the server. The bandwidth is limited by over-subscription from multiple other GPUs. In another embodiments, data-network configuration can be a half-bandwidth intra-server NVLinks. In this example, all eight tensor core GPUs 1008 can half-subscribe eighteen NVLinks to GPUs in other servers. Four tensor core GPUs 1008 can saturate eighteen NVLinks to GPUs in other servers. This is equivalent of full-bandwidth on AllReduce with Scalable Hierarchical Aggregation and Reduction Protocol (SHARP). The reduction in all-2-all (All2All) bandwidth is a balance with server complexity and costs. In at least one embodiment, all eight tensor core GPUs 1008 can independently transfer data, using Remote Direct Memory Access (RDMA) protocol, over its own dedicated switch (e.g., 400 Gb/s HCA/NIC) in an multi-rail InfiniBand/Ethernet configuration. In this example, 1000 GBps of aggregate full-duplex to non-NVLink network devices.

The computing system 1000 includes various types of interconnects. One or more of the interconnects may include one or more of the transceivers 516, 536 as described above with reference to FIGS. 5A-5B. Accordingly, in embodiments optical shuffle boxes as described herein may be used to connect GPUs 1008 and switches 1010, for example.

In at least one embodiment, the computing system 1000 is used for high-speed network communication and includes a processing unit (e.g., CPU 1002, CPU 1002, switches 1006, tensor core GPUs 1008, switches 1010, high-speed transceiver modules 1012), and a network interface coupled to the processing unit. The network interface can the controller as described above with respect to FIG. 8.

Other variations are within the spirit of the present disclosure. Thus, while disclosed techniques are susceptible to various modifications and alternative constructions, certain illustrated embodiments thereof are shown in drawings and have been described above in detail. It should be understood, however, that there is no intention to limit the disclosure to a specific form or forms disclosed, on the contrary, the intention is to cover all modifications, alternative constructions, and equivalents falling within the spirit and scope of the disclosure, as defined in appended claims.

Use of terms “a” and “an” and “the” and similar referents in the context of describing disclosed embodiments (especially in the context of following claims) are to be construed to cover both singular and plural, unless otherwise indicated herein or clearly contradicted by context, and not as a definition of a term. Terms “comprising,” “having,” “including,” and “containing” are to be construed as open-ended terms (meaning “including, but not limited to,”) unless otherwise noted. The term “connected,” when unmodified and referring to physical connections, is to be construed as partly or wholly contained within, attached to, or joined together, even if there is something intervening. Recitations of ranges of values herein are merely intended to serve as a shorthand method of referring individually to each separate value falling within the range, unless otherwise indicated herein, and each separate value is incorporated into the specification as if it were individually recited herein. Use of the term “set” (e.g., “a set of items”) or “subset,” unless otherwise noted or contradicted by context, is to be construed as a nonempty collection comprising one or more members. Further, unless otherwise noted or contradicted by context, the term “subset” of a corresponding set does not necessarily denote a proper subset of the corresponding set, but the subset and corresponding set can be equal. The use of terms such as “first,” “second,” “third,” “fourth,” “fifth,” “sixth,” “seventh,” “eighth,” “ninth,” etc., are not intended to designate a particular order, unless specified.

Conjunctive language, such as phrases of the form “at least one of A, B, and C,” or “at least one of A, B, and C,” unless specifically stated otherwise or otherwise clearly contradicted by context, is otherwise understood with the context as used in general to present that an item, term, etc., can be either A or B or C, or any nonempty subset of a set of A and B and C. For instance, in an illustrative example of a set having three members, conjunctive phrases “at least one of A, B, and C” and “at least one of A, B, and C” refer to any of the following sets: {A}, {B}, {C}, {A, B}, {A, C}, {B, C}, {A, B, C}. Thus, such conjunctive language is not generally intended to imply that certain embodiments require at least one of A, at least one of B, and at least one of C each to be present. In addition, unless otherwise noted or contradicted by context, the term “plurality” indicates a state of being plural (e.g., “a plurality of items” indicates multiple items). A plurality is at least two items but can be more when so indicated either explicitly or by context. Further, unless stated otherwise or otherwise clear from context, the phrase “based on” means “based at least in part on” and not “based solely on.”

Operations of processes described herein can be performed in any suitable order unless otherwise indicated herein or otherwise clearly contradicted by context. In some embodiments, a process such as those processes described herein (or variations and/or combinations thereof) is performed under the control of one or more computer systems configured with executable instructions and is implemented as code (e.g., executable instructions, one or more computer programs or one or more applications) executing collectively on one or more processors, by hardware or combinations thereof. In some embodiments, code is stored on a computer-readable storage medium, for example, in form of a computer program comprising a plurality of instructions executable by one or more processors. In some embodiments, a computer-readable storage medium is a non-transitory computer-readable storage medium that excludes transitory signals (e.g., a propagating transient electric or electromagnetic transmission) but includes non-transitory data storage circuitry (e.g., buffers, cache, and queues) within transceivers of transitory signals. In some embodiments, code (e.g., executable code or source code) is stored on a set of one or more non-transitory computer-readable storage media having stored thereon executable instructions (or other memory to store executable instructions) that, when executed (i.e., as a result of being executed) by one or more processors of a computer system, cause a computer system to perform operations described herein. A set of non-transitory computer-readable storage media, in some embodiments, comprises multiple non-transitory computer-readable storage media and one or more of individual non-transitory storage media of multiple non-transitory computer-readable storage media lacks all of the code while multiple non-transitory computer-readable storage media collectively store all of the code. In some embodiments, executable instructions are executed such that different instructions are executed by different processors—for example, a non-transitory computer-readable storage medium stores instructions, and a main central processing unit (CPU) executes some of the instructions while a graphics processing unit (GPU) executes other instructions. In some embodiments, different components of a computer system have separate processors, and different processors execute different subsets of instructions.

Accordingly, in some embodiments, computer systems are configured to implement one or more services that singly or collectively perform operations of processes described herein, and such computer systems are configured with applicable hardware and/or software that enable the performance of operations. Further, a computer system that implements at least one embodiment of present disclosure is a single device and, in another embodiment, is a distributed computer system comprising multiple devices that operate differently such that distributed computer system performs operations described herein and such that a single device does not perform all operations.

Use of any and all examples or exemplary language (e.g., “such as”) provided herein is intended merely to better illuminate embodiments of the disclosure and does not pose a limitation on the scope of the disclosure unless otherwise claimed. No language in the specification should be construed as indicating any non-claimed element as essential to the practice of the disclosure.

In description and claims, the terms “coupled” and “connected,” along with their derivatives, can be used. It should be understood that these terms cannot be intended as synonyms for each other. Rather, in particular examples, “connected” or “coupled” can be used to indicate that two or more elements are in direct or indirect physical or electrical contact with each other. “Coupled” can also mean that two or more elements are not in direct contact with each other but yet still co-operate or interact with each other.

Unless specifically stated otherwise, it can be appreciated that throughout specification terms such as “processing,” “computing,” “calculating,” “determining,” or like, refer to action and/or processes of a computer or computing system or similar electronic computing device, that manipulates and/or transform data represented as physical, such as electronic, quantities within computing system's registers and/or memories into other data similarly represented as physical quantities within computing system's memories, registers or other such information storage, transmission or display devices.

In a similar manner, the term “processor” can refer to any device or portion of a device that processes electronic data from registers and/or memory and transform that electronic data into other electronic data that can be stored in registers and/or memory. As non-limiting examples, a “processor” can be a CPU or a GPU. A “computing platform” can comprise one or more processors. As used herein, “software” processes can include, for example, software and/or hardware entities that perform work over time, such as tasks, threads, and intelligent agents. Also, each process can refer to multiple processes for carrying out instructions in sequence or in parallel, continuously, or intermittently. The terms “system” and “method” are used herein interchangeably insofar as a system can embody one or more methods, and methods can be considered a system.

In the present document, references can be made to obtaining, acquiring, receiving, or inputting analog or digital data into a subsystem, computer system, or computer-implemented machine. Obtaining, acquiring, receiving, or inputting analog and digital data can be accomplished in a variety of ways, such as by receiving data as a parameter of a function call or a call to an application programming interface. In some implementations, the process of obtaining, acquiring, receiving, or inputting analog or digital data can be accomplished by transferring data via a serial or parallel interface. In another implementation, the process of obtaining, acquiring, receiving, or inputting analog or digital data can be accomplished by transferring data via a computer network from providing entity to acquiring entity. References can also be made to providing, outputting, transmitting, sending, or presenting analog or digital data. In various examples, the process of providing, outputting, transmitting, sending, or presenting analog or digital data can be accomplished by transferring data as an input or output parameter of a function call, a parameter of an application programming interface, or an interprocess communication mechanism.

Although the discussion above sets forth example implementations of described techniques, other architectures can be used to implement described functionality and are intended to be within the scope of this disclosure. Furthermore, although specific distributions of responsibilities are defined above for purposes of discussion, various functions and responsibilities might be distributed and divided in different ways, depending on circumstances.

Furthermore, although the subject matter has been described in language specific to structural features and/or methodological acts, it is to be understood that subject matter claimed in appended claims is not necessarily limited to specific features or acts described. Rather, specific features and acts are disclosed as exemplary forms of implementing the claims.

What is claimed is:

1. A method, comprising:
sending a first number of packets to a destination device via a first network path based on a packet sending criterion;
sending a second number of packets to the destination device via a second network path based on the packet sending criterion;
receiving an acknowledgement from the destination device, wherein the acknowledgement comprises a first indication that one or more of the first number of packets arrived at the destination device; and
determining that at least one packet sent via the first network path was dropped based on the first number of packets and the first indication.

2. The method of claim 1, wherein a plurality of packets comprise the first number of packets and the second number of packets, wherein the plurality of packets is associated with a plurality of sequential numbers, wherein each packet of the plurality of packets has a packet sequence number (PSN) of the plurality of sequential numbers.

3. The method of claim 2, wherein the first number of packets comprise a first set of PSNs of the plurality of sequential numbers and the second number of packets comprise a second set of PSNs of the plurality of sequential numbers.

4. The method of claim 2, wherein the plurality of packets are sequentially numbered based on when each packet of the plurality of packets is sent.

5. The method of claim 2, further comprising:
determining the packet sending criterion based on the plurality of packets.

6. The method of claim 1, further comprising:
responsive to determining that the at least one packet sent via the first network path was dropped, determining a first connectivity status of the first network path.

7. The method of claim 1, wherein determining that at least one packet sent via the first network path was dropped comprises:
determining, from the first indication, the one or more of the first number of packets that arrived at the destination device satisfy a first threshold based on the first number of packets.

8. The method of claim 7, wherein a value of the first threshold matches a quantity of the first number of packets.

9. The method of claim 7, wherein a last packet of the first number of packets is not received at the destination device, wherein a value of the first threshold matches a quantity of the first number of packets minus one.

10. A network device comprising:
a memory; and
one or more processing devices coupled with the memory, the one or more processing devices to:
obtain a plurality of packets to be sent to one or more receiver devices via a plurality of network paths based on a packet transmission schema, wherein the packet transmission schema indicates a first set of packets of the plurality of packets are to be sent via a first network path of the plurality of network paths and a second set of packets of the plurality of packets are to be sent via a second network path of the plurality of network paths;
send the first set of packets via the first network path;
receive at least one acknowledgement message from the one or more receiver devices, wherein the acknowledgement message comprises a first indication that a third set of packets was received at the one or more receiver devices;
determine that the third set of packets satisfies a first criterion of the packet transmission schema; and
responsive to determining that the third set of packets satisfies the first criterion, determine a first connectivity status of the first network path, the first connectivity status indicating a first packet loss rate for the first network path.

11. The network device of claim 10, the one or more processing devices further to:
determine, based on the plurality of packets, the packet transmission schema.

12. The network device of claim 10, the one or more processing devices further to:
send the second set of packets via the second network path,
wherein the acknowledgement message further comprises a second indication that a fourth set of packets were received;
determine that the fourth set of packets do not satisfy a second criterion of the packet transmission schema; and
responsive to determining that the fourth set of packets do not satisfy the second criterion, determine a second connectivity status of the second network path, the second connectivity status indicating a second packet loss rate for the second network path.

13. The network device of claim 10, wherein to determine that the third set of packets satisfies the first criterion, the one or more processing devices to:
determine that the third set of packets satisfies a first threshold based on the first set of packets; and
responsive to determining that the third set of packets satisfies the first threshold, indicate that the third set of packets satisfies the first criterion.

14. The network device of claim 13, wherein the packet transmission schema indicates that the first set of packets comprises a first number of packets and the second set of packets comprises a second number of packets, and wherein the third set of packets comprises a third number of packets.

15. The network device of claim 14, wherein to determine that the third set of packets satisfies the first threshold, the one or more processing devices to:
determine that the third number of packets matches the first number of packets.

16. The network device of claim 14, wherein the one or more processing devices further to:
determine a first rate of the first network path based on the first number of packets and the third number of packets.

17. The network device of claim 10, wherein packets of the plurality of packets are sequentially numbered, wherein the first set of packets are associated with a first subset of packet sequence numbers and the second set of packets are associated with a second subset of packet sequence numbers, wherein a highest packet number of the first subset of packet sequence numbers is less than a lowest packet number of the second subset of packet sequence numbers.

18. The network device of claim 17, wherein the packets of the plurality of packets are sequentially numbered based on when each packet of the plurality of packets is sent by the network device.

19. The network device of claim 17, wherein the first indication of the third set of packets comprises a third subset of packet sequence numbers corresponding to the first subset of packet sequence numbers.

20. A system for high-speed network communication, the system comprising:
one or more processing units; and
a network interface coupled to the one or more processing units, wherein the network interface comprises a transceiver and a controller coupled to the transceiver, wherein the transceiver to transmit a plurality of packets via a communication network, the controller to:
sending a first number of packets to a destination device via a first network path based on a packet sending criterion;
sending a second number of packets to the destination device via a second network path based on the packet sending criterion;
receiving an acknowledgement from the destination device, wherein the acknowledgement comprises a first indication that one or more of the first number of packets arrived at the destination device; and
determining that at least one packet sent via the first network path was dropped based on the first number of packets and the first indication.
